(19) United States
(12) Patent Application Publication
(10) Pub. No.: US 2006/0004909 A1
(43) Pub. Date: Jan. 5, 2006

(54) Server system and a server arrangement method

(76) Inventors: Shinya Takuwa, Sagamihara (JP); Hiroyuki Igata, Yamato (JP); Daisuke Sasaki, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/060,424

(22) Filed: Feb. 18, 2005

(30) Foreign Application Priority Data
Apr. 30, 2004 (JP) 2004-136095

(51) Int. Cl. G06F 15/16

(52) U.S. Cl. 709/203

(57) ABSTRACT

In a server system, functions of blade servers can be visually recognized at a glance. A change in load due to a failure can be detected to modify the system configuration by changing functions of blade servers. The server system includes a blade system including servers having different function types, the servers being installed in one or more stages in one enclosure, and a managing server for managing the blade system. The managing server includes a first managing section for classifying the servers into groups, a second managing section for managing a state of arrangement of the servers in the enclosure, and an arrangement changing section for changing functions of the servers discretely and for changing arrangement of the servers in the enclosure by replacing functions of the servers. The arrangement changing section arranges the servers in the enclosure on a function basis of the servers.

### INCORPORATION BY REFERENCE

The present application claims priority from Japanese application JP2004-136095 filed on Apr. 30, 2004, the content of which is hereby incorporated by reference into this application.

### BACKGROUND OF THE INVENTION

The present invention relates to a server system and a server arrangement method, and in particular, to a server system and a server arrangement method in which a plurality of servers are housed in one enclosure.

JP-A-2004-110791 describes a conventional technique regarding a server system called a blade system including a plurality of servers housed in one enclosure. In the blade system, a plurality of servers (to be referred to as blade servers hereinbelow) each of which including one board or a plurality of circuit boards are housed in one enclosure. The blade servers include servers having a plurality of different functions.

For example, maintenance of the blade system is generally conducted in a method in which a schedule of maintenance jobs are beforehand determined. According to information of the schedule, maintenance jobs such as modifications of functions and arrangement of servers in the blade system are conducted to change a configuration of the blade system. The maintenance is conducted with intervention of a maintenance engineer or an operator.

### SUMMARY OF THE INVENTION

The conventional blade system includes blade servers having different functions housed in the enclosure in a mixed way. In general, however, the function of each blade server cannot be readily identified by outside appearance thereof. Therefore, at maintenance of the blade system, it possibly occurs that a maintenance engineer mistakenly checks a blade server other than a target blade server. When the conventional blade system stops its operation due to, for example, a failure of a blade server mounted in the system, there may occur a case in which balance of load cannot be appropriately kept for each of the functions of the blade servers. This leads to, for example, a situation in which a blade server of which the load is resultantly increased cannot satisfactorily conduct services, and hence a business chance is lost.

It is therefore an object of the present invention, which has been devised to solve the problem of the background art, to provide a server system and a server arrangement method in which a function of each blade server of a blade system can be readily identified or recognized by outside appearance and arrangement of the blade servers of the blade system can be changed. In addition, any change in the load caused by a failure is sensed to modify functions of the blade servers to thereby change the configuration of the blade system.

To achieve the object according to the present invention, there is provided a server system including a blade system including a plurality of servers including servers of different function types, the servers being installed in one or more stages in one enclosure and a managing server for managing the blade system. The managing server changes a function of each of the servers.

To achieve the object according to the present invention, there is provided a server system including a blade system including a plurality of servers including servers of different function types, the servers being installed in one or more stages in one enclosure, and a managing server for managing the blade system. The managing server includes a first managing section for classifying the servers into groups to thereby manage the servers, a second managing section for managing a state of arrangement of the servers in the enclosure, and an arrangement changing section for changing functions of the respective servers and for changing arrangement of the servers in the enclosure by replacing functions of the servers. The arrangement changing section arranges the respective servers in the enclosure for each of the functions of the servers.

To achieve the object according to the present invention, there is provided a sever arrangement method for use in a server system comprising a blade system including a plurality of servers including servers of different function types, the servers being installed in one or more stages in one enclosure, and a managing server for managing the blade system. The method includes the steps of classifying by the managing server the servers into groups to thereby manage the servers, managing by the managing server a state of arrangement of the servers in the enclosure, changing functions of the respective servers and changing arrangement of the servers in the enclosure by replacing functions of the servers, and arranging, through the arrangement change by the managing server, the respective servers in the enclosure for each of the functions of the servers.

According to the present invention, the servers can be arranged for each function of the servers and it is hence possible to facilitate maintenance thereof. In addition, according to the present invention, when one of the servers fails and balance of load imposed on the other servers is broken, it is possible to automatically replace functions of the servers. Therefore, processing performance of the blade system can be used to the maximum extent until the system maintenance is carried out.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an example of a configuration of a server system according to the present invention.

FIG. 2 is a block diagram showing an example of a configuration of a blade server.

FIG. 3 is a diagram showing a layout of a server type managing table of a managing server.

FIG. 4 is a diagram showing a layout of a blade server managing table of the managing server.

FIG. 5 is a flowchart to explain processing of a blade server arrangement change in an automatic delivery schedule section.

FIG. 6 is a diagram showing a layout example of a new blade server managing table after the arrangement change.

FIG. 7 is a flowchart to explain processing of blade server rearrangement when a storage device is connected by a Device Attached Storage (DAS).

FIG. 8 is a flowchart to explain processing of a reserved server position change in Step 603 of FIG. 7.

FIG. 9 is a diagram showing a server arrangement state after the reserved server position change.

FIG. 10 is a flowchart to explain processing of a blade server arrangement change when a storage device is connected by a Storage Are Network (SAN).

FIG. 11 is a diagram showing an example of a monitor view of an arrangement state of a plurality of blade servers displayed on a display.

FIG. 12 is a diagram showing a state of light emitting diodes turned on in an actual device corresponding to the display view example shown in FIG. 11.

FIG. 13 is a diagram showing an example of a monitor view of an arrangement state of a plurality of blade servers 3 displayed on a display 24 in a blade system including a plurality of stages and groups including a plurality of blades.

FIG. 14 is a diagram showing a state of light emitting diodes (LEDs) turned on in an actual device corresponding to the display view example shown in FIG. 13.

FIG. 15 is a diagram to explain a manual operation to modify arrangement of the blade servers in a blade using the display view.

FIG. 16 is a flowchart to explain processing of blade server rearrangement initiated when a button of “Execute Arrangement” is depressed in the view shown in FIG. 15.

### DESCRIPTION OF THE EMBODIMENTS

Referring now to the drawings, description will be given in detail of embodiments of a server system and a server arrangement method according to the present invention.

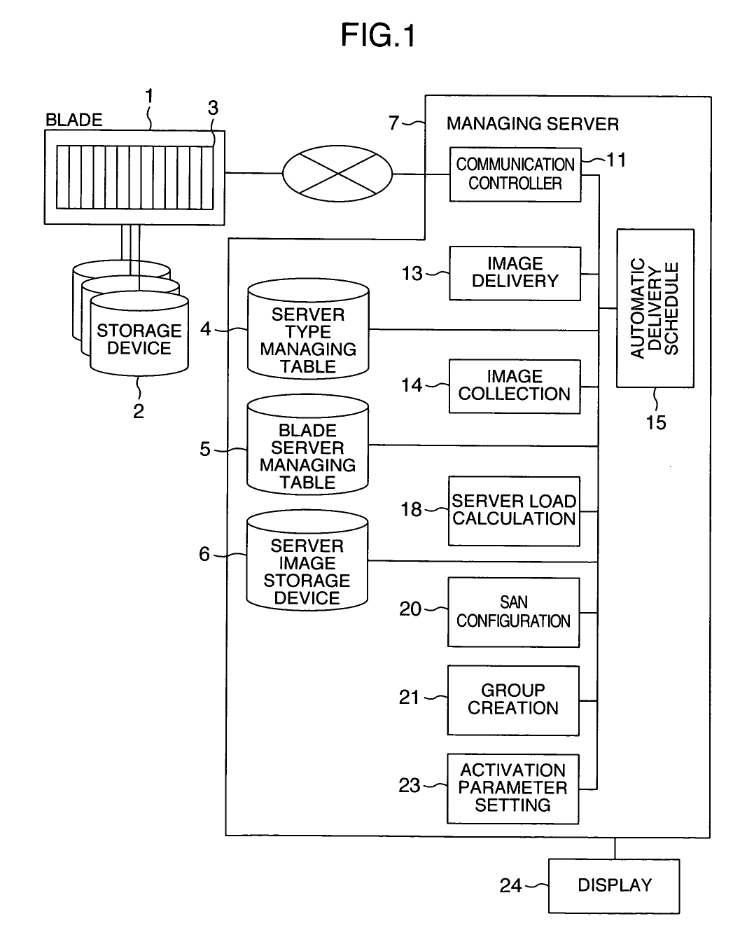

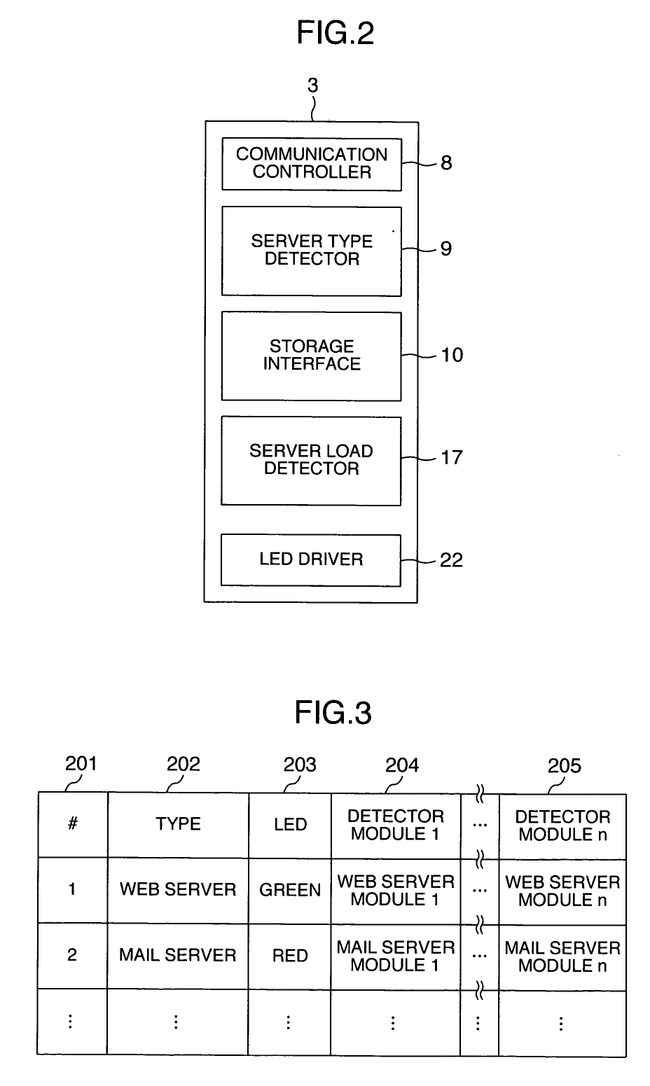

FIG. 1 shows in a block diagram an example of a configuration of a server system in the embodiment. FIG. 2 is a block diagram showing an example of a configuration of a blade server. In FIGS. 1 and 2, the server system includes a blade system 1 (to be simply referred to as a blade hereinbelow), a storage device 2, blade servers 3, a server type managing table 4, a blade server managing table 5, a server image storage device 6, a managing server 7, communication controllers 8 and 11, a storage device interface 10, an image delivery section 13, an image collecting section 14, an automatic delivery schedule section 15, a server load detector 17, a server load calculating section 18, a storage device area network (SAN) configuration section 20, a group creator 21, an LED driver 22, an activation parameter setting section 23, and a display 24. The tables 4 and 5 are stored in a memory of the managing server 7.

As can be seen from FIG. 1, the embodiment of the server system includes a blade 1 including a plurality of blade servers 3. The servers 3 are respectively installed in a plurality of slots disposed in one enclosure. The server system also includes a storage device 2 connected to the blade servers 3 and a managing server 7 disposed according to the embodiment. Each blade server 3 of the blade 1 is a computer to operate independently. The computer includes basic functions of a server such as functions respectively of a central processing unit (CPU), a memory, and an external input/output interface and is connected to the storage device 2. The blade server 3 may include one board or more. When the server 3 includes a plurality of circuit boards, the boards are housed in a plurality of slots of the enclosure.

The blade servers 3 housed in the enclosure include servers of mutually different types of functions. The blade 1 includes a load distributing unit, not shown. The unit is controlled to uniformly distribute load to the blade servers 3 for each function type. FIG. 1 shows only one blade in which the blade servers are housed in the enclosure. However, it is also possible to dispose a plurality of blades 1 respectively in a plurality of stages of shelves arranged in one enclosure. When the blade system includes a plurality of stages, one stage may be entirely assigned to one blade 1 or two or more stages may be assigned thereto. Additionally, the blade servers of one stage may be classified into a plurality of groups such that each group configures one blade 1.

The managing server 7 is connected via a network or the like to all blade servers 3 in the blade 1 to manage the blade servers 3. However, the managing serve 7 may also be constructed in one of the servers 3. The managing server 7 includes a communication controller 11 to control communication with the blade servers 3, an image delivery section 13 to deliver a server image (module) to the blade servers 3, an image collecting section 14 to collect images from the blade servers 3, an automatic delivery schedule section 15 to execute processing to, for example, modify the arrangement of the blade servers 3 in the blade 1 according to the embodiment, a server load calculating section 18 to calculate a load on each blade server 3, a Storage Area Network (SAN) configuration section 20 to set an SAN configuration when the storage device 2 is connected using an SAN, a group creating section 21 to classify the blade servers 3 into groups, an activation parameter setting section 23, a display 24 to display an arrangement state of the blade servers 3, a server type managing table 4 to manage the blade servers 3 for each function type, a blade server managing table 5 to manage, for example, arranging positions of the blade servers 3 in the blade 1, and a server image storage device 6 to keep server images to be delivered to the blade servers 3.

The blade server 3 includes, as shown in FIG. 2, a communication controller 8 to control communication with the managing server 7, a server type detector 9 to detect a function type of the blade server 3, a storage device interface 10 as an interface for the storage device 2, a server load detector 11 to detect a load state of the blade server 3, an LED driver 22 to drive an LED corresponding to the function type of the blade server 3 and an LED indicating a state of, for example, a failure; and a plurality of LEDs, not shown, to emit light in colors corresponding to function types and an LED, not shown, to indicate a state of a failure or the like.

In the embodiment configured as above, the storage device 2 is in a configuration of a Device Attached Storage (DAS) or a Storage Area Network (SAN) and is connected via the storage device interface 10 of the blade server 3. When the storage device 2 is connected via an SAN, an SAN configuration is set by a fibre channel switch via a Host Bus Adapter (HBA).

The managing server 7 manages the blade servers 3 in one blade 1 or a plurality of blades 1 by registering the blade servers 3 to the groups created by the group creating section 21. The automatic delivery schedule section 15 of the managing server 7 modifies or changes the arrangement and the function types of the blade servers 3 according to the embodiment. The processing of the modification will be described later in detail.

The server type detector 9 of the blade server 3 conducts, in response to a request from the managing server 3, communication via the communication controller 8 thereof and the communication controller 11 of the managing server 7 to detect a software module (indicating, for example, a Simple Mail Transfer Protocol (SMTP) server or a HyperText Transfer Protocol (HTTP) server) installed in the blade server 3 and decide the server type.

The image delivery section 13 of the managing server 7 delivers an image stored in the server image storage device 6 via the communication controller 11 and the communication controller 8 of the blade server 3 to a target blade server 3. After the image is delivered, the target blade server 3 restores the original state of the delivered image, reads therefrom information unique to the target server 3 set by the activation parameter setting section 23, and activates an operating system (OS). In the embodiment, the image indicates a backup image of the storage device 2 connected to the pertinent blade server 3. The image collecting section 14 of the managing server 7 collects an image of the target blade server 3 via the communication controller 8 of the target blade server 3 and stores the image in the server image storage device 9.

The processing in the image delivery section 13 and the image collection section 14 can be executed only when operation of the target blade server 3 is stopped for a predetermined period of time. That is, the target blade server is set to a stopped state for the image collection and delivery. The server load detector 17 of the blade server 3 measures a load imposed thereon. In this case, the load may be, for example, a CPU utilization ratio, i.e., a mean value of CPU utilization ratios measured at a predetermined interval of time. The results of the measurement are sent to the managing server 7 via the communication controller 8 and the communication controller 11 of the managing server 7.

The server load calculating section 18 of the managing server 7 has a function to obtain, for each function type of the blade server 3, a mean value of results measured by the server load detector 17. The section 18 also has a function to be used when the number of servers varies for a particular function type. If the number thereof is changed, the function is used to predict a mean value of the load. The prediction may be conducted using, for example, a method in which the total of loads for the function type is divided by the number of the servers of the function type when the variation in the number of the servers is assumed. The group creating section 21 of the managing server 7 creates groups of blade servers to be managed respectively in a unified manner and registers the blades 1 or blade servers 3 to the associated groups. By registering a plurality of blades 1 or blade servers 3 to one group, the managing server 7 can manage these servers according to the group.

The SAN configuration creating section 20 of the managing server 7 has a function to create, when the storage device 2 is connected to the blade 1 using an SAN, a configuration of a fibre channel switch to set the configuration to the switch. The LED driver 22 of the blade server 3 makes a check, at activation of the blade server 3, to determine to which one of the function types the blade server 3 belongs. The driver 22 accordingly indicates or drives an LED of the function type as shown in FIG. 3 to turn the LED on using a table, which will be described later. During the processing of the image delivery section 13, the activation parameter setting section 23 of the managing server 7 refers to information unique to an image delivery target server 3. The section 23 has a function to set the information unique to the blade server.

FIG. 3 shows a layout of the server type managing table 4 of the managing server 7. The table 4 will be next described.

The server type managing table 4 of FIG. 3 is disposed to manage the blade servers 3 for each function type. Each entry of the table 4 includes fields of a blade server number 201, a function type 202, an LED 203 to indicate a color of an associated LED, and detection modules 1 to n (204, 205). The function type 202 indicates a function of the server, for example, a WEB server or a mail server. The LED 203 indicate a color of the LED to be turned on for the function. Each of the detection modules 204 and 205 is used to determine that a module detected by the server type detector 9 belongs to a function of, for example, an SMTP server, a Post Office Protocol (POP) server, or an HTTP server. Even when servers has the same function, for example, the function of a WEB server, the servers may have mutually different modules. Therefore, the servers are classified using the detection modules 1 to n in the registration.

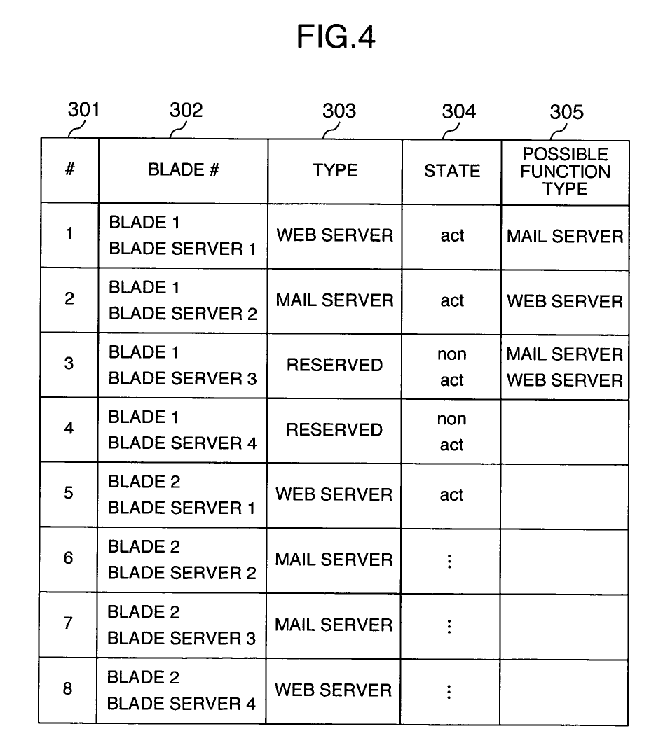

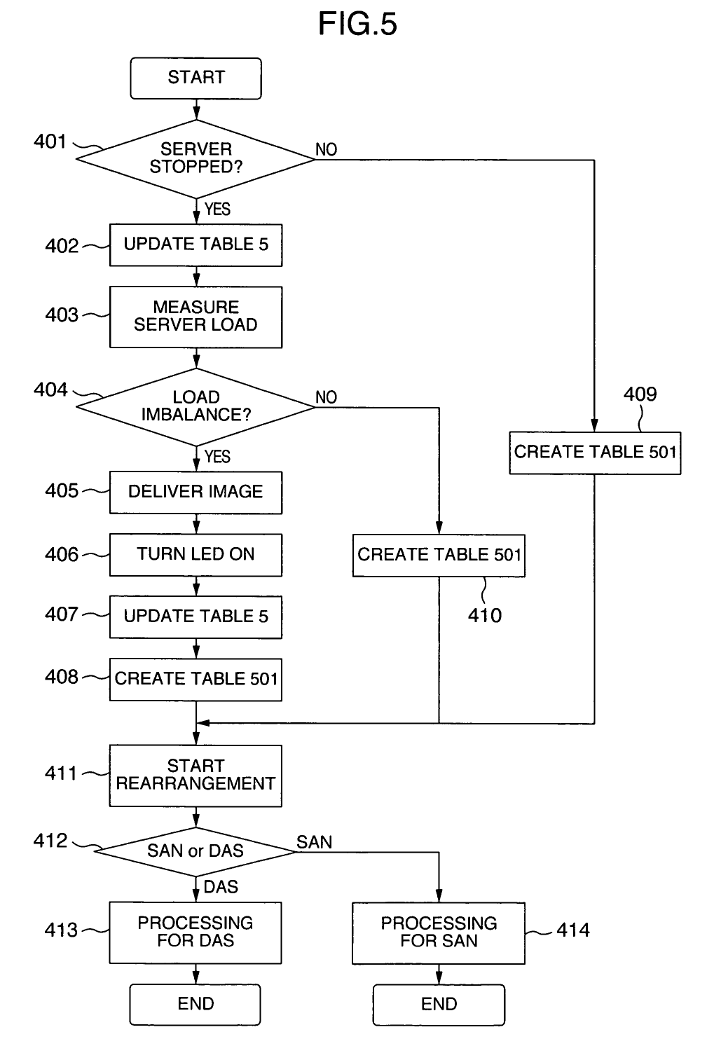

FIG. 4 shows a layout of the blade server managing table 5 of the managing server 7. The table 5 will be next described.

The table 5 is disposed to manage an arrangement position of each blade server 3 in an associated blade. Each entry of the table 5 includes fields of a blade server # 301 indicating a position at which the blade server is housed in the enclosure, a blade # 302, a function type 303, a state 304 indicating whether the server is in operation (act) or not in operation (non act), and an executable function 305. The blade # 302 includes a blade # and a blade server # of each blade server registered according to an associated group. The function type 303 indicates a type possessed by the server associated with the blade # and corresponds to the type 202 of FIG. 3. The executable function 305 is used, when the storage device 2 is a DAS and is directly connected to the blade server, to store a module name stored in the storage device in an executable state. Any blade server diagnosed as “failed” is not registered to the table 5.

Assume that the #s 301 in FIG. 4 are ordered in a sequence determined for each group, that is, in a sequential order of registration of the blade and are substantially equal in the sequence to the blade servers housed in the enclosure of the blade. In the example of registration of the blade server managing table 5 shown in FIG. 4, two blades each of which including four blade servers 3 are classified into one group. In this situation, two blades are configured in one enclosure. However, it is also possible in the registration, when the system includes a multi-stage enclosure, that all blade servers housed in one stage of the enclosure form one blade and two or more blades thus configured form one group. When a function type is determined in the function type 303, the functions and applications included in the blade servers of the function type are uniquely determined according to the group. For example, in the layout shown in FIG. 4, all blade servers having a function type of “WEB server” execute only functions and applications respectively equivalent to each other.

FIG. 5 is a flowchart to explain processing to change the blade server arrangement by the automatic delivery schedule section 15. The processing will now be described. In the example of processing, the functions shown in FIG. 3 are limited to the WEB and mail servers. The processing is periodically activated or is activated when one of the blade servers is stopped due to, for example, a failure.

(1) When the processing is started, the section 15 makes a check to determine whether or not the processing is started because one blade server is stopped. If this is the case, the section 15 deletes the blade server from the table 5 shown in FIG. 4 to resultantly update the table 5 (Steps 401 and 402).

(2) When one blade server is stopped, the load distributing unit of the blade 1, not shown, conducts load distribution to distribute the load of the stopped blade server to the blade servers having the same function type as the stopped blade server. Therefore, the server load calculating section 18 of the managing server 7 collects load states of the blade servers of the associated function type from the server load detector 17, calculates a mean load for each blade server, and determines whether or not the load is excessive for each of the blade servers of the function type, that is, whether or not the load state is within an allowable range of each blade server (Steps 403 and 404).

(3) In Step 404, for the blade servers having the same type as the stopped blade server, if the load of the blade server is excessive and is beyond the allowable range. That is, in a situation in which, for example, a WEB server is stopped and the load of the other WEB servers becomes excessive due to the state in which the WEB server is stopped, the section 15 makes a check to determine whether or not the table 5 includes reserved servers. If there exist such reserved servers, an image of the WEB server (a beforehand obtained image of the WEB server in an initial state) is delivered from the image delivery section 13. If such a reserved server is absent, the section 15 calculates the number of mail servers in the group using the table 5 of FIG. 4. If two or more servers are present, the server load calculating section 18 calculates and predicts the load of the mail servers when the number thereof is reduced by one. If it is appropriate to increase the number of WEB servers in this situation, an image of the WEB server (a beforehand collected image) is delivered from the image delivery section 13 to one of the mail servers. If it is not appropriate to increase the number of WEB servers, the section 15 does not execute any particular processing (Step 405).

(4) When a necessary function is installed again or rebooted in the blade server through the image delivery processing in Step 405, the LED driver 22 of the blade server turns an LED of a color assigned to the function on and updates the table 5. The driver 22 then creates, according to information of the updated table 5, a new table after arrangement change to be used to change the blade server arrangement in subsequent processing (Steps 406 to 408).

(5) In Step 401, if the processing is started in response to an event other than the stop of the blade server, that is, if the processing is periodically started, the processing is started to rearrange the blade server. Therefore, according to information of the present blade server managing table 5, the section 15 creates a new table after arrangement change (Step 409).

(6) In Step 404, if the load state is within the allowable range, the section 15 creates a new table after arrangement change according to the information of the table 5 updated through the processing in Step 402 (Step 410).

(7) After the new table after arrangement change is created through the processing in Step 408, 409, or 410, the section 15 starts processing to rearrange the blade servers. In the processing, the section 15 first makes a check to determine whether the storage device 2 is connected to the blade server via a DAS or an SAN (Steps 411 and 412).

(8) In Step 412, if the storage device 2 is connected via a DAS, the section 15 executes processing for DAS, which will be described later in detail. If the storage device 2 is connected via an SAN, the section 15 executes processing for SAN, which will be described later in detail. The section 15 thereby terminates the processing of the blade server rearrangement (Steps 413 and 414).

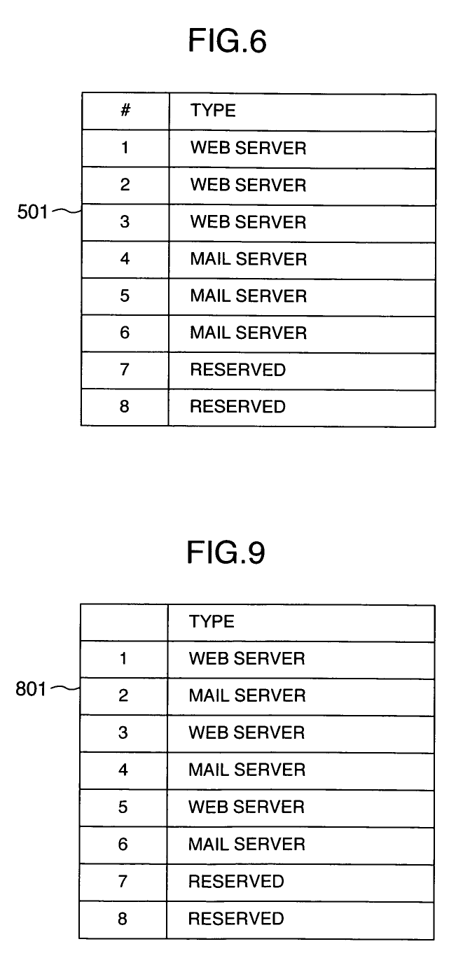

FIG. 6 shows a layout example of the new blade server managing table 501 after arrangement change. The blade server arrangement after arrangement change of this example is obtained through the processing of Step 409 executed for the blade server managing table 5 in the state of FIG. 4. The WEB, mail, and reserved servers are sequentially housed in the enclosure. Thanks to the arrangement of the blade servers for each function type as shown in FIG. 6, a maintenance engineer can easily determine a position of each blade server and hence the maintenance can be more easily achieved. In this connection, the blade servers may be arranged in an arbitrary order after the arrangement positions thereof are changed. The new blade server managing table 501 after arrangement change created in Step 408 or 410 is not necessarily equal to that created in Step 409. However, the new blade server managing table 501 after arrangement change is assumed to be as shown in FIG. 6 in the description below.

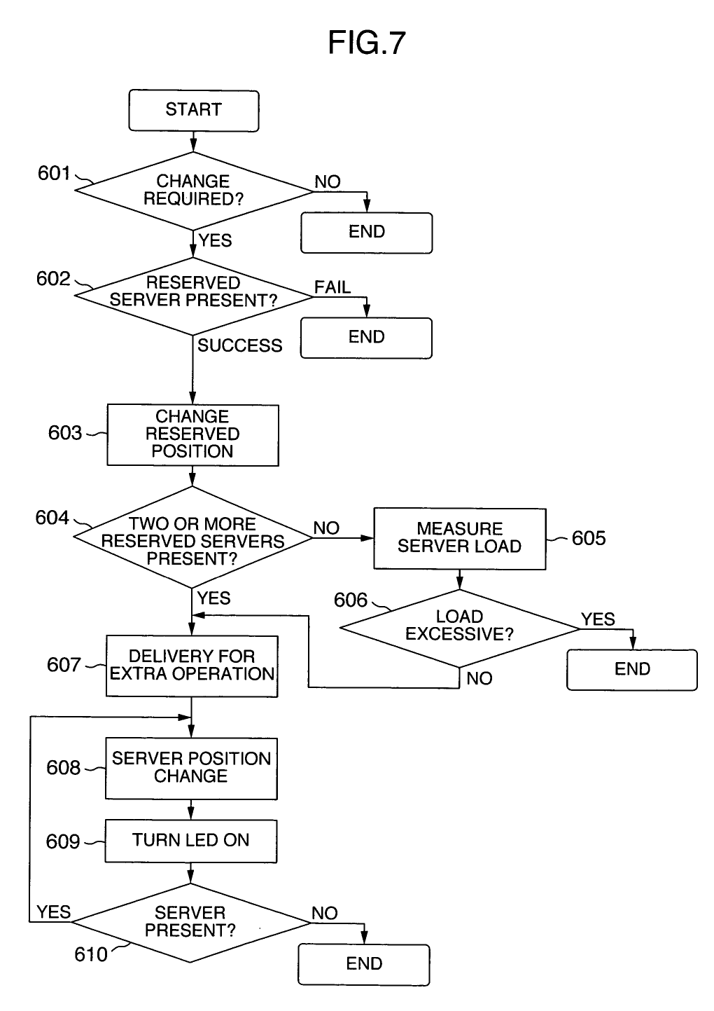

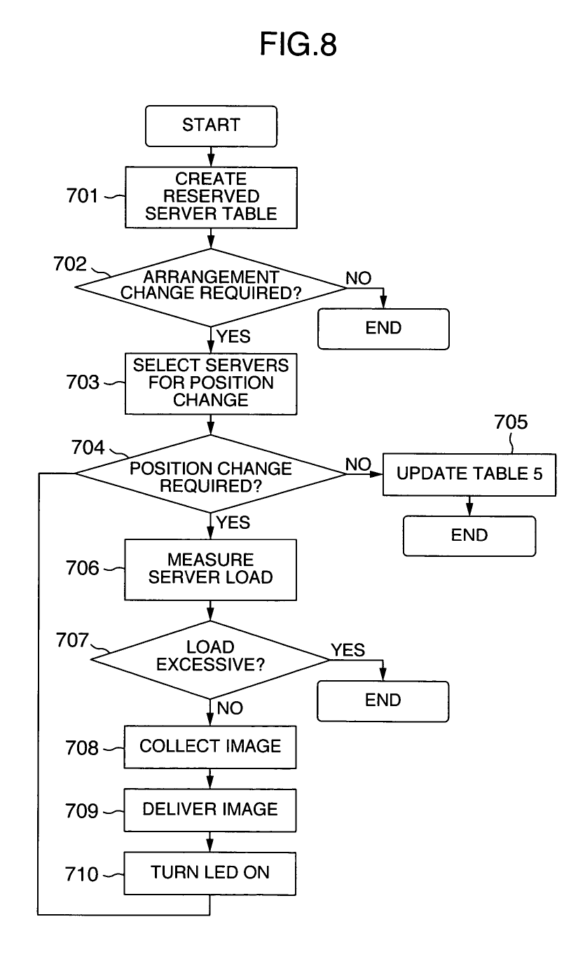

FIG. 7 is a flowchart to explain processing of blade server rearrangement when the storage device 2 is connected via a DAS. FIG. 8 is a flowchart to explain processing of the reserved server position change in Step 603 of FIG. 7. FIG. 9 is a diagram showing a server arrangement state after the reserved server position change. Referring now to FIG. 7, description will be given of the processing to change the blade server arrangement.

(1) First, the original blade server managing table 5 shown in FIG. 4 is compared with the blade server managing table 501 after arrangement change created through the processing in Step 409 to determine whether or not the arrangement is required according to whether or not the tables 5 and 501 are equivalent to each other. If the tables are equivalent, the arrangement is not required and hence the processing is terminated (Step 601).

(2) In Step 601, if the tables are different from each other and the arrangement is required, a check is made to determine whether or not the blade server managing table 5 includes reserved servers registered thereto. If such a reserved server is absent, the change in the server arrangement is not possible and hence the processing is terminated (Step 602).

(3) If such a reserved server is present, the position of the reserved server is changed according to the flowchart of FIG. 8, which will be described later. Through the processing, the reserved server is placed at the end of the table as indicated by a table 801 of FIG. 9. In the processing, since the table includes two reserved servers, the #8 WEB server is moved to the #3 reserved server and the #7 mail server of is moved to the #4 reserved server. Thereafter, the #7 and #8 servers are set as reserved servers to obtain the table 801 in the arrangement shown in FIG. 9 (Step 603).

(4) Next, a check is made to determine whether or not two or more reserved servers are present. If such reserved servers are absent, that is, if there exists only one reserved server, it is required to conduct a degenerated operation according to necessity. Therefore, the state of load of each blade server detected by the server load detector 17 is collected therefrom. Using the collected state of each blade server, the server load calculating section 18 of the managing server 7 predicts load of each blade server in the configuration for the degenerated operation. The degenerated operation is an operation in which when there exists, for example, only one reserved server, either one of the WEB or mail servers is stopped to continuously conduct the operation. In the processing, the server load calculating section 18 predicts the load by taking both cases in consideration. That is, the load is predicted for a case in which one WEB server is removed and a case in which one mail server is removed (Step 605).

(5) A check is made to determine whether or not the calculated value of the load predicted in Step 605 exceeds a reference value of either one of the WEB and mail servers. If the reference value is exceeded, the arrangement change of the blade servers is stopped or is restarted after a lapse of a predetermined period of time. Therefore, the processing is terminated. On the other hand, if it is determined, according to the calculated load value, which one of the WEB and mail servers is to be removed. For example, if it is determined that the load is less affected by reducing one of the WEB servers, the mail server is delivered to a reserved server. In this situation, the image to be delivered is corrected beforehand and has the mail server function (Step 606).

(6) In Step 604, if two or more reserved servers are present, a pair of a WEB server and a mail server are delivered to reserved servers somewhere. In this case, the images to be delivered are also collected in advance. Although the servers created as a result of the image delivery are operated in an extra operation, information unique thereto such as a log obtained during the operation thereof is discarded (Step 607).

(7) Next, the arrangement of the blade servers is changed. In the change of arrangement, two servers A and B associated with each other are determined and images of the servers A and B are simultaneously collected. After the images are collected, the image of the server A is delivered to the server B and that of the server B is delivered to the server A at the same time. For example, when the server B is a reserved server, it is not required to collect the image of the server B. At image delivery, an entry of the table 5 corresponding to the server A is set as a reserved server, and the server A is stopped. The servers A and B include one WEB server and one mail server in any situation. In the example, the state of FIG. 9 is set through the processing in Step 603. Therefore, the #2 mail server and the #5 WEB server are exchanged. As a result, the state of FIG. 6 is obtained. Thereafter, when necessary images are rebooted or installed again in the respective servers, the LED driver 22 of each server turns an LED of a color corresponding to an associated function on (Steps 608 and 609).

(8) If there exists a server to be replaced, the processing is executed again beginning at Step 608. Otherwise, the processing is terminated (Step 610).

Next, referring to the flowchart shown in FIG. 8, description will be given of the processing to place the reserved server at the end of the blade in Step 603.

(1) First, a check is made to determine an entry # of a reserved server in the table 5 shown in FIG. 4 to create a table (called reserved server table A, not shown), indicating the #. The function type of the server associated with the # is also stored in the table A (Step 701).

(2) The table A created in Step 701 is compared with the blade server table 501 after arrangement change shown in FIG. 6. According to whether or not the reserved server position in the table A is equal to that in the table 501, it is determined whether or not the arrangement change is required. If the positions are equal to each other and the arrangement change is not required, the processing is terminated (Step 702).

(3) If the positions are not equal to each other and the arrangement change is required as a result of the determination in Step 702, the reserved server table is accessed to determine reserved servers of which the position are to be changed and a server type of servers to be replaced by the reserved servers. If the position change is required for only one reserved server, the position of the associated server is automatically determined. If the position change is required for two or more reserved servers, the servers associated with the reserved servers are determined, for example, as below. The table 501 is accessed to obtain a # and a current type of an entry having “reserved” in the type field. The # and the type which are the type in the table 5 are stored in a table B. Next, the reserved server table A is scanned in the order of #s to determine whether or not a type corresponding to the type of the table A is present in the table B. If the corresponding type is present, a server associated with the type is determined. The # of the server in the table B thus determined is removed from the table B. If the corresponding type is absent, the process goes to the scanning of the reserved server table A without determining the associated server. When the scanning of the table A is finished, each server of the table A for which an associated server is not determined is appropriately determined as a server remaining in the table B. By determining the associated servers in this way, the server arrangement change of Step 608 shown in FIG. 7 can be achieved with a minimum number of processing steps (Step 703).

(4) Whether or not the server position change is required is determined according to a result of Step 703. If the change is not required, the table 5 is updated to thereby terminate the processing (Steps 704 and 705).

(5) If the change is required as a result of Step 704, a load of the server is calculated for a degenerated operation as described above to determine whether or not the load in the degenerated operation is equal to or larger than a reference value. If the load is equal to or larger than the reference value, the processing is stopped or is restarted after a lapse of a predetermined period of time (Steps 706 and 707).

(6) If the load is smaller than the reference value as a result of Step 707, the processing of image collection and image delivery is executed for the associated server determined through the processing of Step 703 to resultantly conduct the position change. During the position change processing, the pertinent server is temporarily stopped. When the image is rebooted in the server in the position change processing, the LED driver 22 of the server turns an LED of a color corresponding to a function type of the server on (Steps 708 to 710).

As a result of the processing, the state of the blade server managing table arranged as shown in FIG. 4 is changed to that of the table 801 shown in FIG. 9 and the reserved servers are arranged at the end of the table. The servers are placed at positions of the table in an ascending order of their #s.

Description has been given of the blade server rearrangement for DAS in Step 413 of FIG. 5 using the flowcharts shown in FIGS. 7 and 8. In the description of this example, the blade 1 includes at least two reserved blade servers to execute processing at a high speed such that the servers are efficiently rearranged using the reserved servers. However, if it is allowed that the rearrangement takes an particular predetermined period of time, the arrangement processing can be executed when the blade 1 includes one reserved blade server. In this situation, the server rearrangement is conducted using, for example, a method well known as a data sorting method. In the method, the function of a server to be moved is moved to the reserved server to thereby change the server into a reserved server. The position change is repeatedly conducted until the desired server arrangement is obtained. Even when the blade 1 does not include any reserved server, the server rearrangement can be conducted by using a method in which one of the servers of a function type with a lower load is set to a stopped state. By regarding the server as a reserved server, the above processing is executed.

In the method for DAS described above, it is required that the storage device 2 belongs to each blade server and a module featuring a function of the server is delivered as an image to the storage device 2. In any situation, the server is interrupted for the server rearrangement. In the flowchart of FIG. 5, the processing after rearrangement beginning at Step 408 is desirably executed in a state of a lower load in the overall server system. After the table is rearranged through the processing of Step 408 or 410 of FIG. 5, it is favorable to interrupt the processing such that the processing after rearrangement beginning at Step 408 is executed in a zone of time in which the load of the entire server system is reduced, for example, in a midnight time zone.

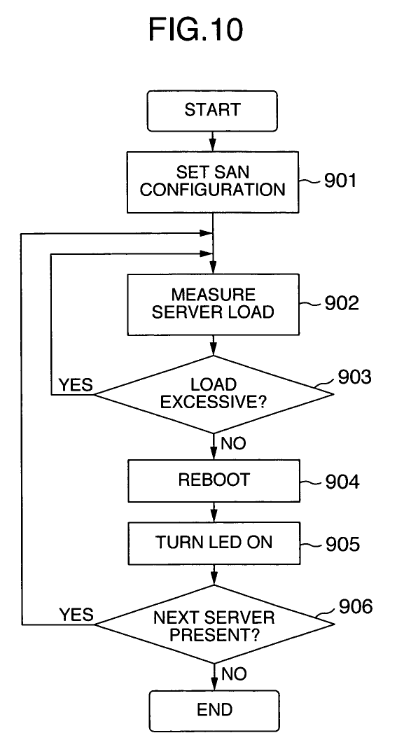

FIG. 10 is a flowchart to explain processing of the blade server rearrangement when the storage device is connected via a Storage Area Network (SAN). The processing will next be described using the flowchart. Assume that the storage device 2 is connected via a fibre cable and a fibre channel switch to each blade server when the storage device 2 is implemented using an SAN.

(1) First, the SAN configuration section 20 of the managing server 7 configures the fibre channel switch to obtain a state of the table 501 after rearrangement created in Step 408 or 410 shown in FIG. 5. The section 20 then sets information of the configuration via the communication controllers 8 and 11 to the fiber channel switch (Step 901).

(2) Next, the section 20 stores in a table C, not shown, #s of servers for which the reboot is required. To reflect setting information to each server by repeatedly executing the processing of Steps 902 to 906 for the servers stored in the table C, the section 20 makes the server load calculating section 18 conduct the load calculation and prediction as described above on assumption that the server is stopped for the reboot operation. According to a load resultant therefrom, the section 20 makes a check to determine whether or not the load is more than a reference value (Steps 902 and 903).

(3) If the load is more than the reference value in Step 903, the processing is executed for a subsequent server in the table C. If the load is not more than the reference value, the reboot operation is conducted by a function of the operating system. When the reboot is finished, the LED driver 22 turns an LED of a color corresponding to the rebooted function on (Steps 904 and 905).

(4) Next, the server for which the reboot is finished is removed from the table C. If the table C includes any server, the processing is repeatedly executed beginning at Step 902. If the table C is empty, the processing is terminated (Step 906).

In the above description, when a blade server of the blade is stopped due to a failure or the like or when the blade server arrangement is disturbed for some reason, the function of the blade server is replaced and the arrangement thereof is changed. However, the managing server in the embodiment continuously monitors the load state of each blade server. When the load exceeds the reference value, the managing server delivers a module of the same function to a reserved server to increase the number of servers having the function. Or, when the load is less than the reference value, the managing server sets a server having the function to a reserved state to decrease the number of servers having the function to resultantly increase the processing efficiency of the overall server system. Also in this situation, for the blade server of which the arrangement is disturbed, the arrangement thereof can be changed.

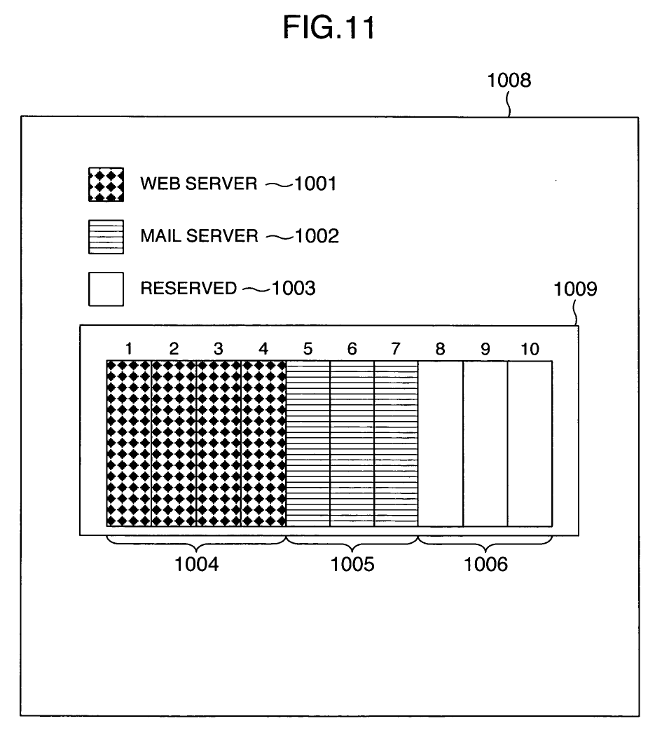

FIG. 11 shows an example of a monitor view of an arrangement state of a plurality of blade servers displayed on the display 24. On a display view 1008 of FIG. 11, display examples 1001 and 1002 respectively indicate server types and LED colors turned on in association therewith. For example, the display example 1001 indicates that the function type of the server is “WEB server” and the LED color is green and the display example 1002 indicates that the function type of the server is “mail server” and the LED color is red. A display example 1003 indicates a reserved state and the LED is not turned on. The blade 1 is represented by a frame 1009. In this example, the blade 1 includes WEB servers 1004, mail servers 1005, and reserved locations 1006. Each blade server 3 displayed on the display view 1008 indicates its physical position. The WEB and mail servers 1004 and 1005 as blade servers and the reserved locations 1006 are displayed in the respective colors described above.

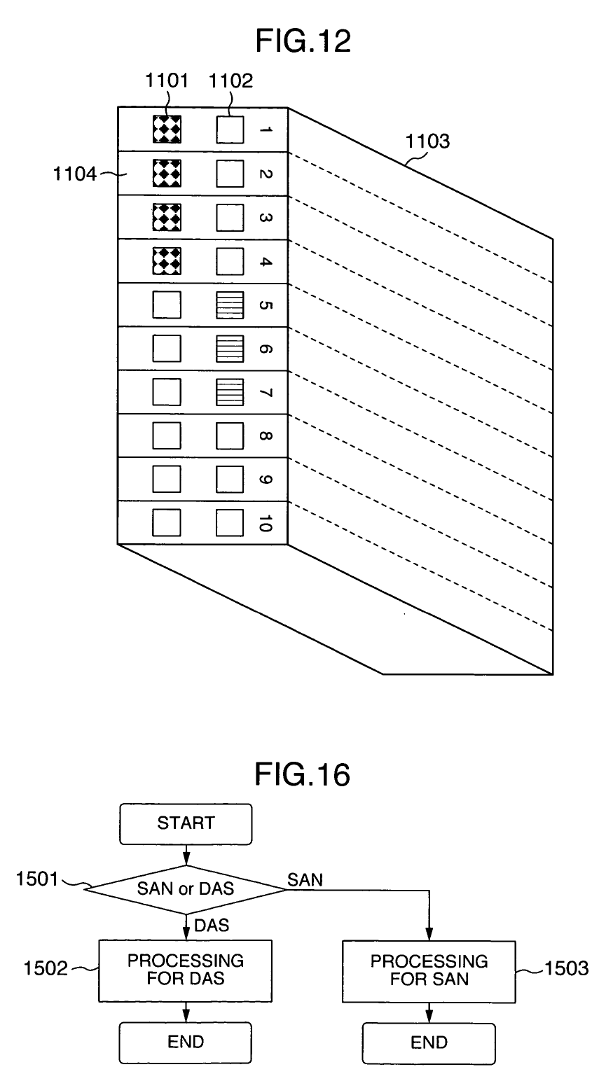

FIG. 12 shows a state of LEDs turned on in an actual device corresponding to the display view example shown in FIG. 11. In FIG. 12, an area 1101 indicates a green LED an area 1102 indicates a red LED. A device 1103 indicates the blade 1. Each box 1104 in the blade 1 indicates a blade server 3.

Thanks to the display image shown in FIG. 11, the maintenance engineer can immediately recognizes the arrangement of the blade servers 3 in the blade 1 on the monitor view. Also in the actual device, as can be seen from FIG. 12, the LEDs of colors are turned on in association with the blade servers of the respective function types. Therefore, the maintenance engineer can recognize the function of each blade server at once.

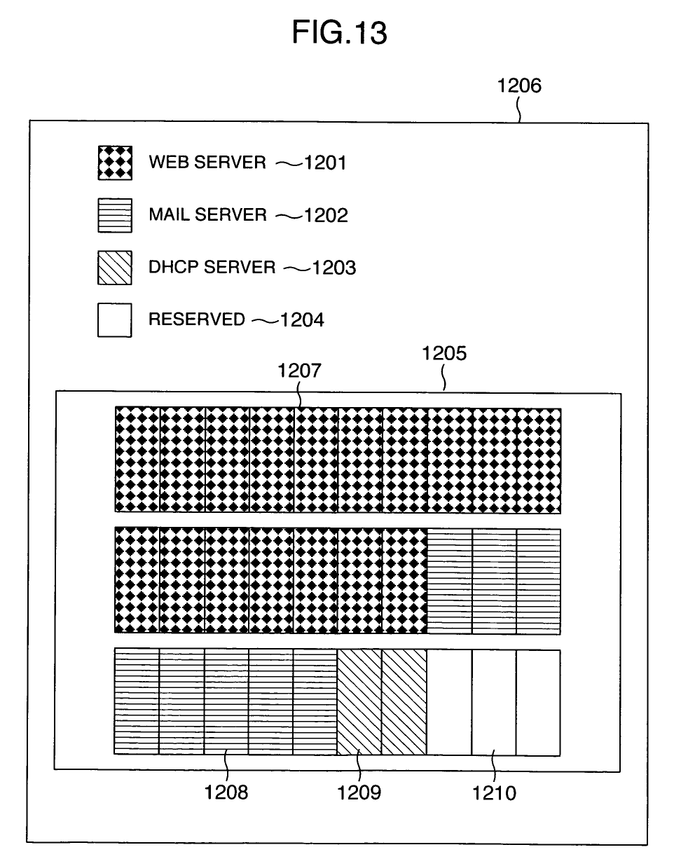

FIG. 13 shows an example of a monitor view of an arrangement state of a plurality of blade servers 3 displayed on the display 24 in a blade system including a plurality of stages and groups including a plurality of blades.

On a display view 1206 of FIG. 13, display examples 1201, 1202, and 1003 respectively indicate server types and LED colors turned on in association therewith. For example, the display example 1201 indicates that the function type of the server is “WEB server” and the LED color is green, the display example 1202 indicates that the function type of the server is “mail server” and the LED color is red, and the display example 1203 indicates that the function type of the server is “DHCP server” and the LED color is blue. A display example 1204 indicates a reserved state and the LED is not turned on. A frame 1205 indicates an enclosure to house the blade 1. An area 1207 indicates WEB servers, an area 1208 indicates mail servers, an area 1209 indicates DHCP servers, and an area 1210 indicates reserved locations. Each blade server 3 displayed on the display view 1205 indicates its physical position. The WEB, mail, DHCP servers 1207, 1208, and 1209 as blade servers and the reserved locations 1210 are displayed in the respective colors described above.

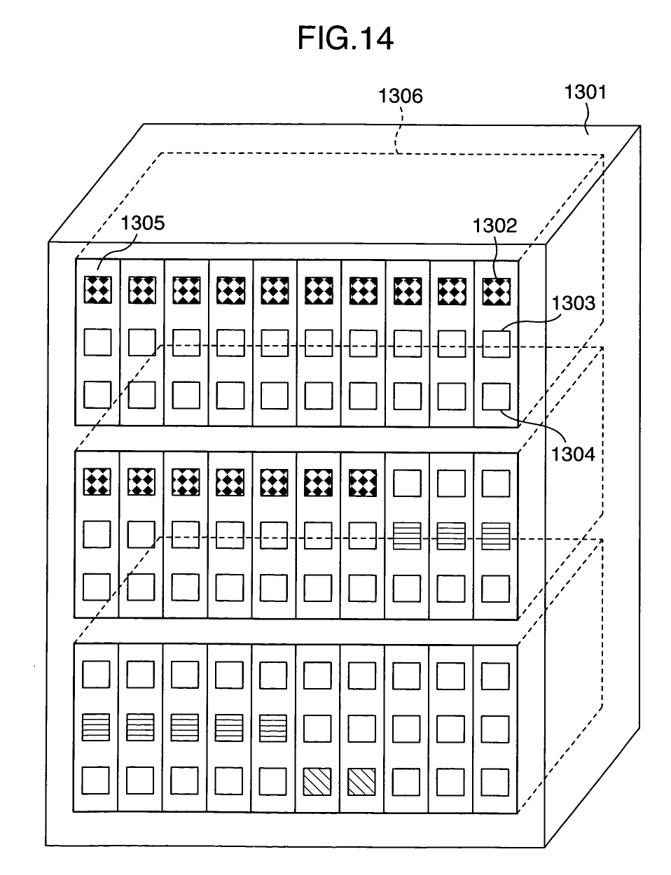

FIG. 14 shows a state of LEDs turned on in an actual device corresponding to the display view example shown in FIG. 13. In FIG. 14, an area 1302 indicates a green LED, an area 1303 indicates a red LED, and an area 1304 indicates a blue LED. A box 1306 is the blade 1 and an area 1305 indicates a blade server 3. A box 1301 is an enclosure in which a plurality of blades are housed.

By displaying an image as shown in FIG. 13, the maintenance engineer can immediately recognizes, on the monitor view, the state of arrangement of the blade servers 3 in each blade 1. Also in the actual device, as can be seen from FIG. 14, the LEDs of colors are turned on in association with the blade servers of the respective function types, and hence the maintenance engineer can recognize the function of each blade server at once.

In the description of the display example of the monitor view and the LEDs turned on in the actual device, the WEB, mail, and DHCP servers are associated respectively with green, red, and blue. However, it is possible to arbitrarily establish a correspondence between the function types of the servers and colors. In the actual device, to display colors, there may also be employed lighting devices and indicator elements other than the LEDs only if the devices and elements can display colors. In the description of FIGS. 11 to 14, the colors are assigned respectively to the function types of the blade servers to display the colors by turning associated LEDs on. However, to easily recognize a blade server set to a stopped state due to a failure or the like, there may be used a device to display the failure using a color other than those of the function types or to provide a means for blinking, for example, an LED indicating the failure.

Each processing of the embodiment can be implemented as a processing program. Such a program can be stored in a hard disk (HD), a digital audio taperecorder (DAT), a floppy disk (FD), a digital versatile disk-read-only memory (DVD-ROM), a compact disc-ROM (CD-ROM), and the like to be supplied to the user.

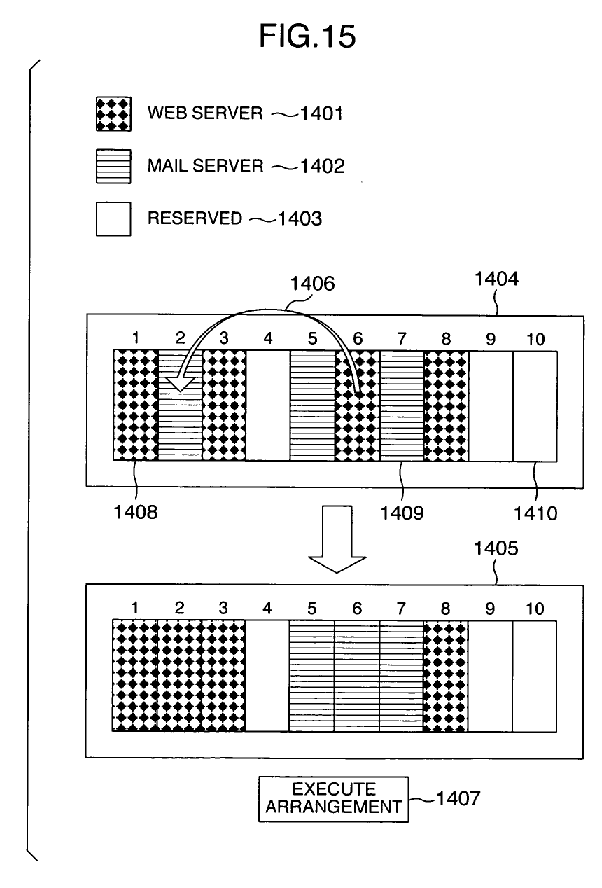

FIG. 15 is a diagram to explain a manual operation to modify arrangement of the blade servers in the blade 1 using the display view.

In FIG. 15, display examples 1401 and 1402 respectively indicate server types and LED colors turned on in association therewith as in the cases described above. For example, the display example 1401 indicates that the server function type is “WEB server” and the LED color is green. The display example 1402 indicates that the server function type is “mail server” and the LED color is red. A display example 1403 indicates a reserved location and there does not exist any LED to be turned on.

Assume that the arrangement of a blade is displayed in a frame 1404 on the monitor display view. In the arrangement, the WEB servers 1408, the mail servers 1409, and the reserved locations 1410 are arranged in an arbitrary order. Assume that layout of the items is manually rearranged using a view operation. In this situation, as indicated by an arrow mark 1406, the operator moves a sixth WEB server to a position of a second mail server through a drag-and-drop using a mouse. As a result, the server type of the drag source server and that of the drag destination server are changed to obtain a frame 1405 including the blade arrangement on the display view. After the blade arrangement is determined through the manual operation as above, when the operator clicks a button “Execute Arrangement” on the view by the mouse, the managing server 7 starts processing to rearrange the blade servers.

FIG. 16 is a flowchart to explain the processing of the blade server rearrangement started when the button “Execute Arrangement” is depressed on the view shown in FIG. 15. In the flow, the contents of processing in Steps 1501, 1502, and 1503 are substantially equal to those of processing in Steps 412, 413, and 414 described using FIG. 5 and hence description thereof will be avoided. Assume that the table after arrangement described using FIG. 6 is constructed when the operation is conducted on the display view.

It is also possible that a program to achieve the server arrangement method of the embodiment is stored in a computer-readable storage device medium. The program is read therefrom to be loaded in a memory and is then executed.

In general, in the blade system management, there occur a job to remove a blade server from and to insert a blade server in the blade system and a job to operate a reset button disposed in each server. The conventional blade systems include few devices for a maintenance engineer to visually recognize a target server. This possibly leads to an erroneous operation, which causes serious damage to the blade system.

According to the embodiment, there can be provided a function which classifies the servers into groups of respective function types to automatically conduct arrangement of the servers. This enhances easy maintenance of the servers. There possibly occurs an event in which one of the servers installed in the server system fails due to a failure requiring a maintenance job and the load on the other servers become imbalanced due to the failed server. According to the embodiment, there can be provided a function to evade the difficulty. The function automatically replaces functions of servers to obtain balanced load on the servers. As a result, during a period of time until the system maintenance is conducted, the processing performance of the blade system can be used to the maximum extent.

It should be further understood by those skilled in the art that although the foregoing description has been made on embodiments of the invention, the invention is not limited thereto and various changes and modifications may be made without departing from the spirit of the invention and the scope of the appended claims.

1. A server system, comprising:
a blade system including a plurality of servers, the servers being installed in one or more stages in one enclosure and including servers of different function types; and
a managing server for managing the blade system,
wherein the managing server changes a function of each of the servers.

2. The server system according to claim 1, wherein at change of a function of a server, the managing server delivers an image collected in the system or an image beforehand obtained to a server to thereby change the function of the server.

3. The server system according to claim 1, wherein the managing server is one of the servers of the blade system.

4. A server system, comprising:
a blade system including a plurality of servers, the servers being installed in one or more stages in one enclosure and including servers of different function types; and
a managing server for managing the blade system, wherein:
the managing server includes a first managing section for classifying the servers into groups to thereby manage the servers, a second managing section for managing a state of arrangement of the servers in the enclosure, and an arrangement changing section for changing functions of the servers discretely and for changing arrangement of the servers in the enclosure by replacing functions of the servers, and
the arrangement changing section arranges the servers in the enclosure in blocks on a function basis of the servers.

5. The server system according to claim 4, wherein:
the managing server includes a load state monitoring section for monitoring a state of load on each of the servers; and
the load state monitoring section activates the arrangement changing section when a failure occurs in one of the servers and loads on servers having a same function as the failed server becomes larger than a reference value.

6. The server system according to claim 4, wherein:
the managing server is connected to a display; and
the display is used to display a state of arrangement of the servers in the enclosure in different colors for the functions of the servers.

7. The server system according to claim 4, wherein each of the servers in the blade system includes a lighting section of a color corresponding to the function thereof.

8. A server arrangement method for use in a server system comprising: a blade system including a plurality of servers, the servers being installed in one or more stages in one enclosure and including servers of different function types; and a managing server for managing the blade system, the method executed by the managing server comprising the steps of:
classifying the servers into groups to manage the servers;
managing a state of arrangement of the servers in the enclosure; and
changing functions of the respective servers discretely and changing arrangement of the servers in the enclosure by replacing functions of servers,
whereby, through the arrangement change by the managing server, the servers are arranged in the enclosure in blocks on a function basis of the servers.

9. The server arrangement method according to claim 8, the method of executed by the managing server further comprising the steps of:
monitoring a state of load on each of the servers; and
replacing functions of servers, when a failure occurs in one of the servers and load on servers having a same function as the failed sever becomes larger than a reference value.

10. A storage device medium for storing on a computer-readable medium a program to execute the server arrangement method according to claim 8.
